(19) United States
(12) Patent Application Publication
(10) Pub. No.: US 2024/0248384 A1
(43) Pub. Date: Jul. 25, 2024

(54) LIGHT SOURCE DEVICE AND PROJECTION DISPLAY APPARATUS

(71) Applicant: Panasonic Intellectual Property Management Co., Ltd., Osaka (JP)

(72) Inventors: Yoshiki Tanaka, Kyoto (JP); Takashi Ikeda, Osaka (JP); Manabu Okuno, Osaka (JP); Makoto Maeda, Nara (JP)

(21) Appl. No.: 18/625,786

(22) Filed: Apr. 3, 2024

Related U.S. Application Data
(63) Continuation of application No. PCT/JP2022/036885, filed on Oct. 3, 2022.

(30) Foreign Application Priority Data
Oct. 5, 2021 (JP) 2021-164290

(51) Int. Cl. G03B 21/20

(52) U.S. Cl. CPC G03B 21/204; G03B 21/2013; G03B 21/2066; G03B 21/2073; G03B 21/208

(57) ABSTRACT

A light source device includes a light source element that emits light source light in a first wavelength region, a selective reflection element that separates the light source light into first light and second light, a first light direction conversion element that reflects the first light guided in a first direction from the selective reflection element in a second direction, and a wavelength conversion element that converts the first light into third light in a second wavelength region. The first light direction conversion element reflects the third light in a third direction opposite to the first direction. The selective reflection element transmits the third light reflected by the first light direction conversion element. The selective reflection element guides the second light and the third light in the third direction. The light source element emits the light source light in a direction different from the second direction.

### BACKGROUND

### 1. Technical Field

The present invention relates to a light source device and a projection display apparatus including the light source device.

### 2. Description of the Related Art

There is conventionally a projection display apparatus that irradiates a phosphor wheel with light from a light source and generates white light using the light from the light source and the generated light.

For example, the projection display apparatus irradiates the phosphor wheel with blue light emitted from a light source to generate fluorescent light, and synthesizes the generated fluorescent light and the blue light emitted from the light source to generate the white light. The white light is further separated into color light of three primary colors and modulated for each color light. The modulated color light is then synthesized again to generate image light.

For example, Patent Literature (PTL) 1 discloses a configuration in which a light source or a phosphor wheel is disposed in both regions across an optical axis as a boundary on which light is emitted from a light source device in plan view, and the phosphor wheel is irradiated with light from the light source. PTL 1 also discloses a light source device that emits blue light and fluorescent light in a time division manner.

PTL 1 is Unexamined Japanese Patent Publication No. 2019-194673.

### SUMMARY

Unfortunately, the light source and the phosphor wheel in the technique disclosed in PTL 1 are disposed surrounding the optical axis of the light emitted from the light source device, so that the light source device increases in size.

It is an object of the present disclosure to provide a light source device that can be downsized and a projection display apparatus.

A light source device according to the present disclosure includes: a light source element that emits light source light that is in a first wavelength region; a selective reflection element that reflects a part of the light source light and transmits a rest of the light source light to separate the light source light into first light and second light; a first light direction conversion element that is disposed at a position for receiving the first light guided in a first direction from the selective reflection element to reflect the first light in a second direction; and a wavelength conversion element that is disposed at a position for receiving the first light reflected in the second direction by the first light direction conversion element to convert the first light into third light in a second wavelength region. The first light direction conversion element reflects the third light received from the wavelength conversion element in a third direction opposite to the first direction. The selective reflection element transmits the third light reflected by the first light direction conversion element. The selective reflection element guides the second light and the third light in the third direction. The light source element emits the light source light in a direction different from the second direction.

Then, a projection display apparatus according to the present disclosure includes: the light source device described above; a light modulator that generates image light by using the second light and the third light emitted from the light source device; and a projection optical system that projects the image light.

The present disclosure can provide a light source device that can be downsized and a projection display apparatus.

### BRIEF DESCRIPTION OF THE DRAWINGS

FIG. 1 is a schematic configuration diagram illustrating a configuration example of a light source device according to a first exemplary embodiment.

FIG. 2 is a front view of a phosphor wheel of the light source device according to the first exemplary embodiment.

FIG. 3 is a schematic configuration diagram illustrating a light source device according to a modification of the first exemplary embodiment.

FIG. 4 is a front view of a selective reflection element according to a modification of the first exemplary embodiment.

FIG. 5A is a schematic configuration diagram illustrating a configuration example of a light source device according to a second exemplary embodiment.

FIG. 5B is an explanatory diagram for illustrating an optical path of light obliquely incident and re-incident on a first light direction conversion element.

FIG. 5C is an explanatory diagram for illustrating an optical path from incidence to re-incidence on a first light direction conversion element according to the second exemplary embodiment.

FIG. 5D is an explanatory diagram for illustrating P-polarized light with respect to the first light direction conversion element according to the second exemplary embodiment.

FIG. 5E is an explanatory diagram for illustrating S-polarized light with respect to the first light direction conversion element according to the second exemplary embodiment.

FIG. 5F is an explanatory diagram illustrating an example of a state of linearly polarized light.

FIG. 6 is a schematic configuration diagram illustrating a configuration example of a light source device according to a third exemplary embodiment.

FIG. 7 is a partially enlarged view of a first light direction conversion element and a selective reflection element of the light source device according to the third exemplary embodiment.

FIG. 8 is a schematic configuration diagram illustrating a configuration example of a light source device according to a fourth exemplary embodiment.

FIG. 9 is a schematic configuration diagram illustrating a configuration example of a light source device according to a fifth exemplary embodiment.

FIG. 10 is a diagram illustrating a configuration of a projection display apparatus according to a sixth exemplary embodiment.

FIG. 11 is a diagram illustrating a configuration of a projection display apparatus according to a seventh exemplary embodiment.

FIG. 12 is a diagram illustrating a configuration of a projection display apparatus according to a modification of the seventh exemplary embodiment.

FIG. 13 is a front view of a wavelength conversion element of the projection display apparatus according to the modification of the seventh exemplary embodiment.

### DETAILED DESCRIPTION

Hereinafter, exemplary embodiments will be described in detail with reference to the drawings as appropriate. However, details more than necessary may not be described. For example, details of a well-known matter and duplication of a substantially identical configuration will not be described in some cases. This is to avoid unnecessary redundancy of the following description and to facilitate understanding of those skilled in the art.

The accompanying drawings and the following description are provided for those skilled in the art to fully understand the present disclosure, and are not intended to limit the subject matter recited in the claims.

### First Exemplary Embodiment

### [1-1. Configuration of Light Source Device]

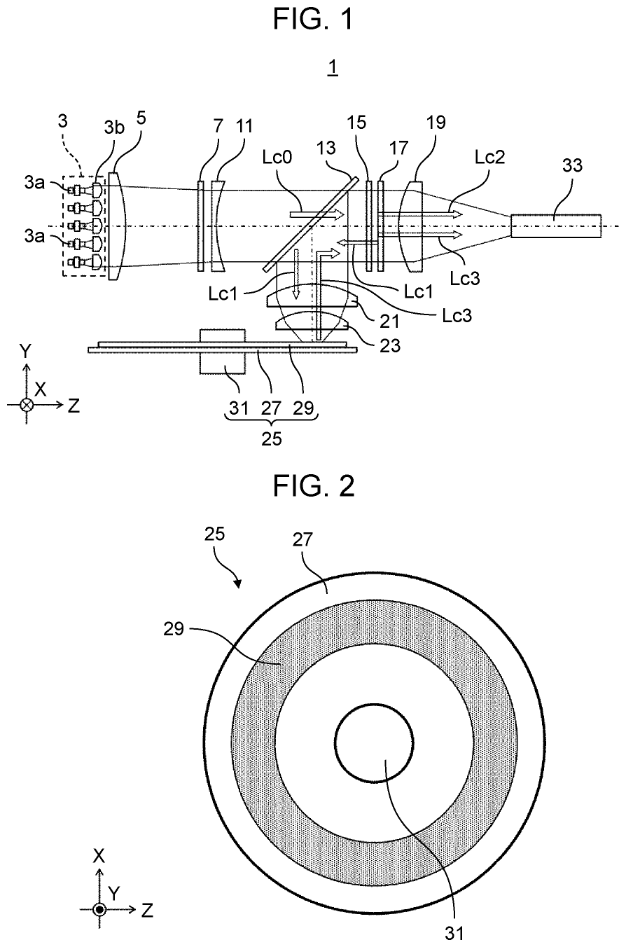

With reference to FIGS. 1 and 2, a light source device according to a first exemplary embodiment will be described below. The light source device according to the first exemplary embodiment will be described when used in a projection display apparatus, for example. FIG. 1 is a schematic configuration diagram illustrating a configuration example of a light source device. FIG. 2 is a front view of a wavelength conversion element. Each drawing indicates a Z direction in which light is emitted from light source unit 3, an XZ plane on which wavelength conversion element 25 receives light and that is formed in the Z direction and an X direction orthogonal to the Z direction, and a Y direction orthogonal to the XZ plane.

Light source device 1 includes light source unit 3, a first light direction conversion element 13, polarization conversion element 15, selective reflection element 17, and wavelength conversion element 25. Light source device 1 further includes: convex lens 5, diffuser plate 7, and concave lens 11 on an optical path between light source unit 3 and first light direction conversion element 13; light condenser lenses 21 and 23 on an optical path between first light direction conversion element 13 and wavelength conversion element 25; and light condensing element 19 and rod integrator 33 in a subsequent stage of selective reflection element 17.

Light source unit 3 includes light source element 3a that emits light source light Lc0 and collimator lens 3b that collimates light source light Lc0 emitted from light source element 3a. Collimator lens 3b is disposed corresponding to light source element 3a, and light source unit 3 includes a plurality of sets of light source element 3a and collimator lens 3b. Light source element 3a emits light in a blue wavelength region as light in a first wavelength region, for example. Light source element 3a is also a laser light source element in the first exemplary embodiment, for example, and a configuration of light source element 3a in which blue light of P-polarized light is emitted will be described.

Collimated light source light Lc0 is incident on convex lens 5 in a subsequent stage to be reduced in width of flux of light, and is incident on and diffused by diffuser plate 7 to be improved in uniformity of light. Light source light Lc0 improved in uniformity of light is incident on concave lens 11 in a subsequent stage to be collimated again.

Light source light Lc0 collimated by concave lens 11 is incident on first light direction conversion element 13 disposed at an angle of approximately 45 degrees with respect to an optical axis. First light direction conversion element 13 is a dichroic-polarization separation minor, for example. First light direction conversion element 13 transmits light source light Lc0 in the first wavelength region emitted from light source element 3a and reflects third light Lc3 that is, for example, yellow light converted in wavelength by wavelength conversion element 25 using light source light Lc0 from light source element 3a as excitation light. Thus, light source light Lc0 incident on first light direction conversion element 13 passes through first light direction conversion element 13, and travels straight without changing a traveling direction to be incident on polarization conversion element 15. As described above, first light direction conversion element 13 has spectral characteristics of transmitting light source light Lc0 that is blue light of P-polarized light (light in the first wavelength region), and reflecting first light Lc1 that is S-polarized blue light, and third light Lc3 that is yellow light to be described later. The yellow light in the second wavelength region is obtained by converting a wavelength of light source light Lc0 using wavelength conversion element 25.

Polarization conversion element 15 is a retardation plate such as a ¼ wave plate, for example. Light source light Lc0 incident on polarization conversion element 15 is converted from blue light of P-polarized light to blue light of circularly polarized light. Light source light Lc0 converted in polarization direction travels straight to be incident on selective reflection element 17.

Selective reflection element 17 reflects a part of light source light Lc0 and transmits the rest of light source light Lc0, so that light source light Lc0 is separated into first light Lc1 to be converted into fluorescent light later and second light Lc2 as blue light, and transmits third light Lc3. Selective reflection element 17 is a single dichroic mirror, for example.

For example, selective reflection element 17 achieves a reflectance (reflectance of selective reflection element 17 for light source light Lc0) of 70% or more for light source light Lc0, and a transmittance (transmittance of selective reflection element 17 for third light Lc3) of 95% or more for third light Lc3. Selective reflection element 17 has a surface on which a dielectric film is uniformly formed to achieve a uniform transmittance of light source light Lc0. A direction opposite to a direction in which light source device 1 emits light is defined as a first direction (a negative direction in the Z direction), a direction in which light travels from first light direction conversion element 13 toward the wavelength conversion element is defined as a second direction (a negative direction in the Y direction), and a direction in which light is emitted from light source device 1 is defined as a third direction (a positive direction in the Z direction). The first exemplary embodiment indicates the first direction in which light is reflected by selective reflection element 17 and travels toward the first light direction conversion element, and the third direction in which also light passes through selective reflection element 17. Light source light Lc0 having passed through selective reflection element 17 travels straight in the third direction to be incident on light condensing element 19.

First light Lc1 reflected by selective reflection element 17 passes through polarization conversion element 15 to be converted from circularly polarized light to S-polarized blue light. First light Lc1 being the S-polarized blue light is reflected in the second direction after the traveling direction is changed by 90 degrees by first light direction conversion element 13. Condenser lenses 21, 23 and wavelength conversion element 25 are disposed on an optical path in the second direction from first light direction conversion element 13. Condenser lenses 21 and 23 are disposed between first light direction conversion element 13 and wavelength conversion element 25.

First light Lc1 reflected in the second direction by first light direction conversion element 13 passes through condenser lens 21 and condenser lens 23 in a subsequent stage to be condensed on wavelength conversion layer 29 in a ring shape provided in wavelength conversion element 25 in a subsequent stage. Wavelength conversion element 25 is a phosphor wheel, for example.

Wavelength conversion element 25 includes substrate 27, wavelength conversion layer 29 stacked on substrate 27, and motor 31 attached to substrate 27. Wavelength conversion element 25 is disposed such that first light Lc1 condensed by condenser lenses 21, 23 is incident on wavelength conversion layer 29 in an annular shape. Wavelength conversion element 25 is rotationally driven by motor 31. Wavelength conversion layer 29 has an incident surface disposed parallel to the third direction, or parallel to the XZ plane.

Wavelength conversion layer 29 generates third light Lc3 from first light Lc1 incident on wavelength conversion layer 29, third light Lc3 being different in wavelength from first light Lc1. For example, wavelength conversion layer 29 is a fluorescent material layer that is formed using a resin body such as silicone or alumina or an inorganic substance as a binder and contains internally a plurality of fluorescent material particles.

The phosphor particles of wavelength conversion layer 29 emit third light Lc3 in a wavelength region longer than a wavelength region of first light Lc1 received. For example, the phosphor particles of wavelength conversion layer 29 are each a Ce-activated YAG-based yellow phosphor that is excited by blue color light received to emit yellow light containing wavelength components of green light and red light. The phosphor particles each include a crystalline matrix with a chemical composition that is typically Y₃Al₅O₁₂.

Between substrate 27 and wavelength conversion layer 29, a reflection layer that reflects third light Lc3 generated in wavelength conversion layer 29 may be disposed. This structure enables third light Lc3 traveling toward substrate 27 in wavelength conversion layer 29 to travel toward first light direction conversion element 13, so that conversion efficiency of fluorescent light can be improved.

As described above, first light Lc1, which is the blue light condensed on wavelength conversion layer 29 of wavelength conversion element 25 by condenser lenses 21 and 23, is not only converted in wavelength into fluorescent light, but also incident on condenser lenses 23, 21 in this order with a traveling direction of light changed by 180 degrees to be collimated. Third light Lc3 being fluorescent light is natural light in a yellow wavelength region, the natural light constituting white light in combination with blue light emitted from light source element 3a, for example.

Third light Lc3 transmitted through condenser lens 21 and collimated is incident on first light direction conversion element 13. As described above, first light direction conversion element 13 has characteristics of reflecting light in the wavelength region of third light Lc3, and thus changes the traveling direction of the light by 90 degrees. Third light Lc3 with the traveling direction changed by 90 degrees by first light direction conversion element 13 passes through polarization conversion element 15 and selective reflection element 17 in subsequent stages to be incident on light condensing element 19.

For example, light condensing element 19 is a condenser lens, and is disposed at a position for receiving light guided by selective reflection element 17 in the third direction. Light condensing element 19 has a subsequent stage in which rod integrator 33 is disposed, and light condensing element 19 condenses incident light on rod integrator 33. Second light Lc2 passing through selective reflection element 17 and third light Lc3 from wavelength conversion element 25 are incident on and condensed by light condensing element 19, and are incident on rod integrator 33 with an incident end disposed at a substantially light condensing position of light condensing element 19. The light having flux uniformed by rod integrator 33 comes out an emission end of rod integrator 33.

### [1-2. Effects and the Like]

As described above, light source device 1 in the first exemplary embodiment includes light source element 3a that emits light source light Lc0 in the first wavelength region, and selective reflection element 17 that separates light source light Lc0 into first light Lc1 and second light Lc2 by reflecting a part of light source light Lc0 and transmitting not only the rest of light source light Lc0, but also third light Lc3 in the second wavelength region. Light source device 1 further includes first light direction conversion element 13 that is disposed at a position for receiving first light Lc1 guided in the first direction from selective reflection element 17 and that reflects first light Lc1 and third light Lc3, and wavelength conversion element 25 that is disposed at a position for receiving light reflected in the second direction by first light direction conversion element 13 and that converts incident first light Lc1 into the third light Lc3. First light Lc1 from selective reflection element 17 is reflected by first light direction conversion element 13 in the second direction, and thus is incident on wavelength conversion element 25. Third light Lc3 received from wavelength conversion element 25 is reflected by first light direction conversion element 13 in the third direction opposite to the first direction, and thus is incident on selective reflection element 17. Selective reflection element 17 guides second light Lc2 and third light Lc3 in the third direction. Light source element 3a emits light source light Lc0 in a direction different from the second direction.

Selective reflection element 17 separates light source light Lc0 into first light Lc1 and second light Lc2 and transmits third light Lc3 in the second wavelength region to guide the second light and the third light in the third direction, so that the second light and the third light can be simultaneously emitted from light source device 1. Additionally, light source element 3a and wavelength conversion element 25 are not required to be disposed facing each other, so that light source device 1 can be downsized.

In particular, light source unit 3 and wavelength conversion element 25 are disposed to align the direction in which light source light Lc0 is emitted from light source element 3a with the direction in which light comes out rod integrator 33, so that light source device 1 can be further downsized.

Although first light direction conversion element 13 in the first exemplary embodiment illustrated in FIG. 1 is disposed at an angle of approximately 45 degrees with respect to the optical axis, the angle of first light direction conversion element 13 with respect to the optical axis may be different from approximately 45 degrees to maximize the spectral characteristics of first light direction conversion element 13. In this case, other components may be disposed in accordance with the angle. Although an example has been here described in which light source light Lc0 emitted from light source element 3a is P-polarized light, a similar configuration is available even for light source light Lc0 emitted from light source element 3a and being S-polarized light.

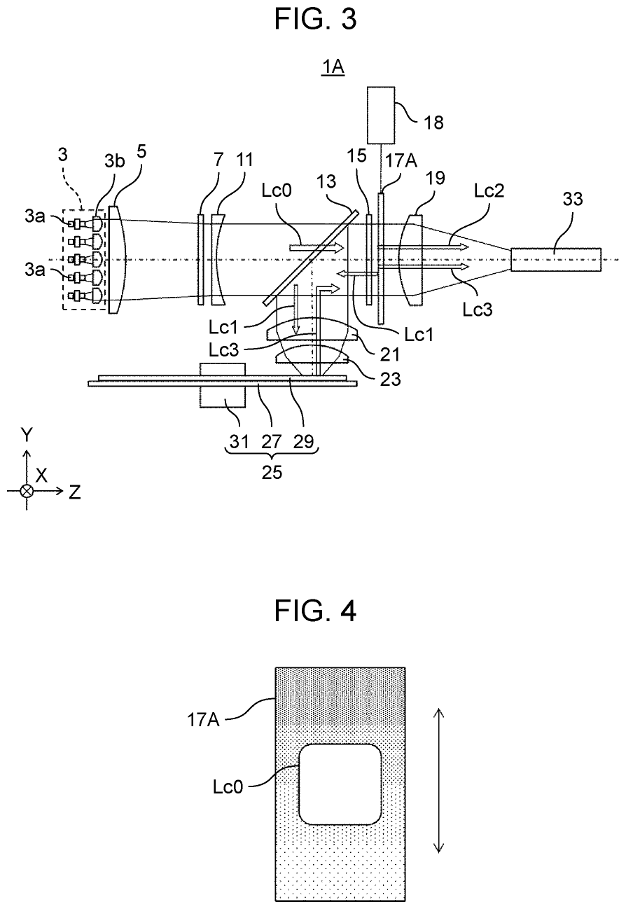

Next, light source device 1A as a modification of light source device 1 of the first exemplary embodiment will be described with reference to FIG. 3. Light source device 1A has a configuration in which selective reflection element 17 of light source device 1 can be displaced. Light source device 1 of the first exemplary embodiment and light source device 1A of the modification are common in configuration other than the point above and the point described below.

Light source device 1A includes selective reflection element 17A having characteristics in which reflectance of light source light Lc0 varies in its plane. As illustrated in FIG. 4, selective reflection element 17A includes a lower region having a large reflectance of light source light Lc0, and the reflectance of light source light Lc0 decreases toward an upper region of selective reflection element 17A. Selective reflection element 17A is configured such that the reflectance of light source light Lc0 (the reflectance of selective reflection element 17A for light source light Lc0) continuously varies along a predetermined direction such as a sliding direction (a direction of an arrow in FIG. 4). Selective reflection element 17A as described above can obtain characteristics as described above by gradually increasing thickness of its reflection film from the lower region toward the upper region, for example.

Light source device 1A includes slide mechanism 18 that slides selective reflection element 17A. Slide mechanism 18 includes a motor, a rack, and a pinion, for example. Selective reflection element 17A is moved in a predetermined direction by slide mechanism 18, thereby varying a ratio between first light Lc1 and second light Lc2 to be guided. Slide mechanism 18 can be operated by a user.

Thus, light source device 1A enables adjusting the amount of light of each of second light Lc2 and third light Lc3 from selective reflection element 17A by adjusting slide of selective reflection element 17A. For example, when a region having a small reflectance of light source light Lc0 of selective reflection element 17A is irradiated with flux of light source light Lc0, the amount of light of second light Lc2 of blue light and the amount of light of third light Lc3 of yellow light, which are to be guided by selective reflection element 17A, can be increased and decreased, respectively. In contrast, when a region having a large reflectance of light source light Lc0 of selective reflection element 17A is irradiated with flux of light source light Lc0, the amount of light of second light Lc2 of blue light and the amount of light of third light Lc3 of yellow light, which are to be guided by selective reflection element 17A, can be decreased and increased, respectively.

As described above, the user can adjust a hue of light to be emitted from light source device 1A by sliding selective reflection element 17A using slide mechanism 18. This adjustment can be used when initial setting of the projection display apparatus is adjusted, for example.

### Second Exemplary Embodiment

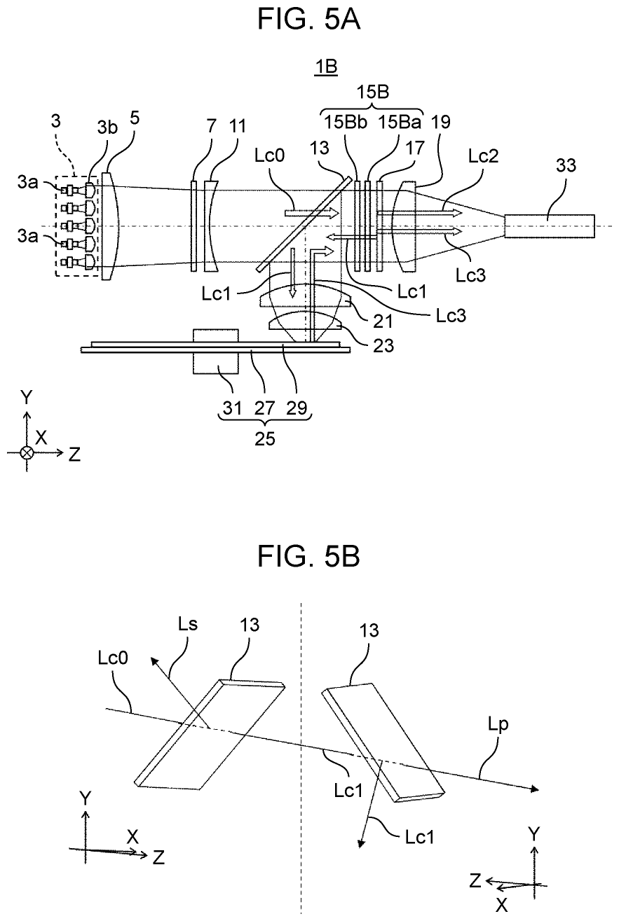

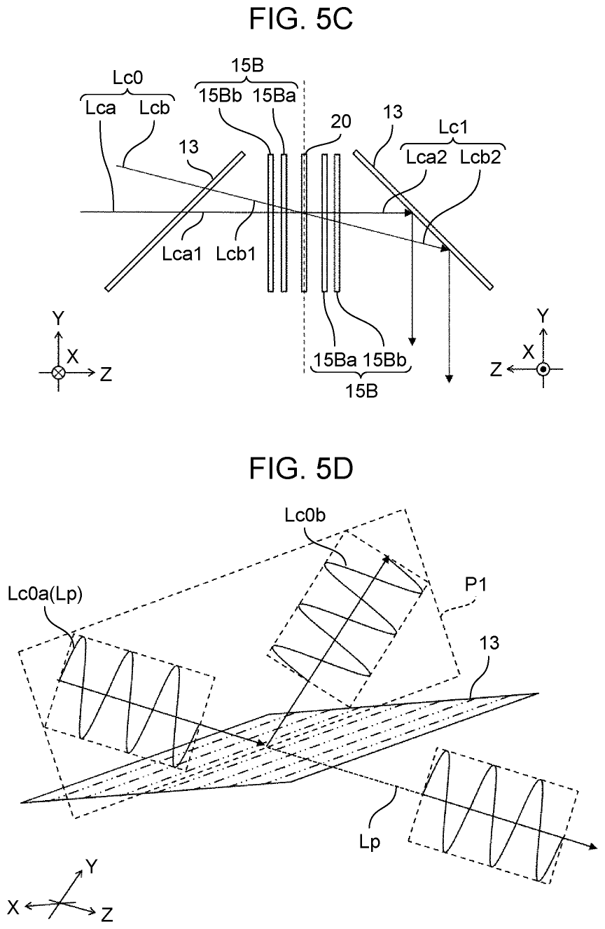

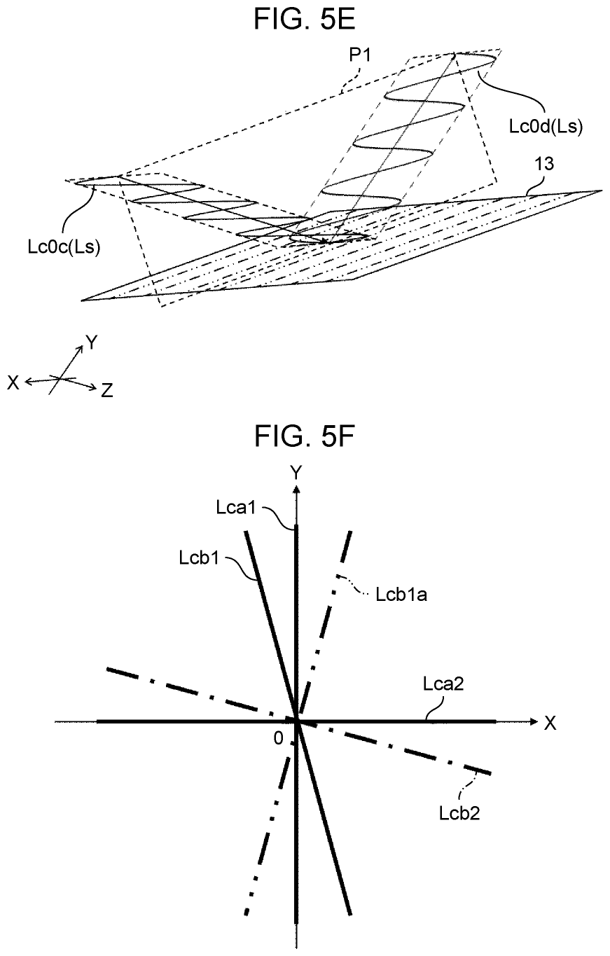

Next, light source device 1B according to a second exemplary embodiment will be described with reference to FIGS. 5A to 5F. FIG. 5A is a schematic configuration diagram illustrating a configuration example of a light source device according to the second exemplary embodiment. FIG. 5B is an explanatory diagram for illustrating an optical path of light obliquely incident and re-incident on a first light direction conversion element according to the second exemplary embodiment. FIG. 5C is an explanatory diagram for illustrating an optical path from incidence to re-incidence on the first light direction conversion element according to the second exemplary embodiment. FIG. 5D is an explanatory diagram for illustrating P-polarized light with respect to the first light direction conversion element. FIG. 5E is an explanatory diagram for illustrating S-polarized light with respect to the first light direction conversion element. FIG. 5F is an explanatory diagram illustrating an example of a state of linearly polarized light.

Although light source device 1 of the first exemplary embodiment includes polarization conversion element 15 including one retardation plate, light source device 1B of the second exemplary embodiment includes polarization conversion element 15B including two ¼ wave plates. Light source device 1B of the second exemplary embodiment and light source device 1 of the first exemplary embodiment are common in configuration other than the point above and the point described below.

When the polarization conversion element includes one ¼ wave plate, separation directions of P-polarized light and S-polarized light are different between a first incidence and a second incidence of blue light on first light direction conversion element 13. Thus, separation performance between the P-polarized light and the S-polarized light may be deteriorated. Light source device 1 of the first exemplary embodiment causes an incident angle on first light direction conversion element 13 to be different between when light source light Lc0 is obliquely incident on first light direction conversion element 13 at the first incidence and when light source light Lc0 is obliquely incident on first light direction conversion element 13 at the second incidence as first light Lc1 after being reflected by selective reflection element 17. Although first light Lc1 having passed through first light direction conversion element 13 at the first incidence mainly includes a P-polarized component, first light Lc1 being obliquely incident on first light direction conversion element 13 may include an S-polarized component, and thus the P-polarized light and the S-polarized light may not be appropriately separated.

Here, the P-polarized light and the S-polarized light against first light direction conversion element 13 will be described. As illustrated in FIG. 5D, P-polarized light Lp is a component of light source light Lc0 incident on first light direction conversion element 13, the component having a vibration plane parallel to plane P1 determined by incident light Lc0a on first light direction conversion element 13 and reflected light Lc0b from first light direction conversion element 13. First light direction conversion element 13 is disposed with its polarization axis parallel to the vibration plane of P-polarized light Lp component of light source light Lc0 traveling on the optical axis, so that most of P-polarized light Lp component of light source light Lc0 incident on first light direction conversion element 13 passes through first light direction conversion element 13. Light source light Lc0 having passed through first light direction conversion element 13, or the vibration plane of P-polarized light Lp, is parallel to plane P1.

As illustrated in FIG. 5E, S-polarized light is a component of light source light Lc0, the component having a vibration plane of an electric field perpendicular to plane P1 determined by incident light Lc0c on first light direction conversion element 13 and reflected light Lc0d from first light direction conversion element 13. Most of S-polarized light component Ls of light source light Lc0 is reflected by first light direction conversion element 13.

Although light source element 3a is disposed such that a vibration plane of light passing through the optical axis of light source light Lc0 emitted from light source unit 3 passes through the polarization axis (transmission axis) of first light direction conversion element 13, light source light Lc0 emitted from light source unit 3 has a certain range of an angle of the vibration plane. Thus, P-polarized light Lp component having passed through first light direction conversion element 13 includes the vibration plane that is not necessarily aligned with the polarization axis of first light direction conversion element 13 depending on an incident direction of light source light Lc0. As described above, the vibration plane of P-polarized component Lp0 of light source light Lc0 having passed through first light direction conversion element 13 varies depending on a direction of incident light.

Although light source light Lc0 is collimated, light source light Lc0 has a certain range of an angle of a traveling direction with respect to the optical axis. Thus, light source light Lc0 also includes a light beam that is incident on first light direction conversion element 13 at an angle with respect to the optical axis in a nonparallel manner. As illustrated in FIG. 5B, when light source light Lc0, which is linearly polarized blue light in the Y-axis direction, is incident on first light direction conversion element 13 at the first incidence from light source unit 3, for example, flux of light source light Lc0 incident on first light direction conversion element 13 at an angle with respect to the optical axis includes a component of S-polarized light Ls perpendicular to incident and exit surfaces determined by incident light and reflected light, respectively, so that a part of the amount of light is reflected by first light direction conversion element 13.

Although FIG. 5B does not illustrate first polarization conversion element 15B and selective reflection element 17, when light having passed through first light direction conversion element 13 is reflected by selective reflection element 17, and is incident on first light direction conversion element 13 again at the second incidence, a direction of the reflected light is different from that at the first incident. Thus, the incident and exit surfaces determined by the incident light and the reflected light, respectively, are different, so that light having passed through first light direction conversion element 13 is not completely converted into the S-polarized light at the second incidence only with one ¼ wave plate, thereby allowing a P-polarized component to pass through first light direction conversion element 13. As described above, light incident on first polarization conversion element 15 while deviating from the optical axis has the amount of light passing through first light direction conversion element 13 at the second incidence, the amount of light causing decrease in light utilization efficiency.

As illustrated in FIGS. 5B and 5C, light source light Lc0 includes a light beam that is not parallel to the Z-axis and has incident and exit surfaces that do not coincide between the first incidence and the second incidence of blue light on first light direction conversion element 13 (see FIG. 5B), and thus, P-polarized light and S-polarized light are different in direction from each other depending on an angle of incident light. P-polarized light (S-polarized light) at the first incidence on first light direction conversion element 13 and P-polarized light (S-polarized light) at the second incidence thereon have respective polarization directions that are substantially symmetric with respect to the Y-axis.

Light source device 1 of the first exemplary embodiment includes the polarization conversion element composed of one ¼ wave plate in which a crystallographic optic axis is disposed at an angle of 45 degrees with respect to the Y-axis. Thus, a light beam not parallel to the Z-axis in the configuration of the first exemplary embodiment causes incident light at the second incidence on first light direction conversion element 13, or light converted from P-polarized light at the first incidence to S-polarized light with a polarization direction turned by 90 degrees, to include the P-polarized component. For this reason, the incident light at the second incidence on first light direction conversion element 13 may include a component that passes through first light direction conversion element 13 and returns to light source unit 3.

In contrast, polarization conversion element 15B of the second exemplary embodiment includes first ¼ wave plate 15Ba and second ¼ wave plate 15Bb with respective crystallographic optic axes that do not coincide with each other. That is, the crystallographic optic axis (first crystallographic optic axis) of first ¼ wave plate 15Ba does not coincide with the crystallographic optic axis (second crystallographic optic axis) of second ¼ wave plate 15Bb. As a result, the polarization direction at the second incidence on first light direction conversion element 13 is caused to further coincide with an S-polarization direction at the second incidence. Polarization conversion element 15B converts linearly polarized light and elliptically polarized light to each other.

Light source light Lc0 includes light Lcb that is obliquely incident on first light direction conversion element 13 with respect to the optical axis. As illustrated in FIG. 5F, light Lcbl that is linearly polarized light of light Lcb having passed through first light direction conversion element 13 is inclined with respect to the Y-axis. When light Lcbl is incident on first light direction conversion element 13 again, the light is to be reflected toward wavelength conversion element 25. At this time, S-polarized light reflected by first light direction conversion element 13 is to be required to have a vibration plane of light Lcb2. The vibration plane of light Lcb2 is obtained by further rotating a vibration plane of light Leh la by 90 degrees, the vibration plane being obtained by converting a vibration plane of light Lcbl in Y-axis symmetry.

Light source light Lc0 includes light Lca that travels along the optical axis and passes through first light direction conversion element 13 to be linearly polarized to serve as light Lcal having a vibration plane along the Y-axis. Thus, when light Lcal is incident on first light direction conversion element 13 again, S-polarized light reflected toward wavelength conversion element 25 serves as light Lca2 having a vibration plane on the X-axis.

First ¼ wave plate 15Ba and second ¼ wave plate 15Bb are disposed between first light direction conversion element 13 and selective reflection element 17. First 1/4 wave plate 15Ba is disposed with a crystallographic optic axis forming an angle of 45 degrees with respect to the Y-axis. When first ¼ wave plate 15Ba is used alone, as in the first exemplary embodiment, the linearly polarized light traveling along the optical axis to be incident on first ¼ wave plate 15Ba (P-polarized light at the first incidence on first light direction conversion element 13) is converted into circularly polarized light, and the circularly polarized light reflected by selective reflection element 17 and being incident on first ¼ wave plate 15Ba again is converted into linearly polarized light (S-polarized light at the first incident on first light direction conversion element 13) acquired by rotating the circularly polarized light by 90 degrees.

Second ¼ wave plate 15Bb is disposed with a crystallographic optic axis parallel or orthogonal to the Y-axis. When second ¼ wave plate 15Bb is used alone, linearly polarized light (P-polarized light at the first incidence on first light direction conversion element 13) with a polarization direction inclined with respect to the Y-axis (crystallographic optic axis) is converted into elliptically polarized light with a major axis coinciding with the crystallographic optic axis regardless of the inclination. The elliptically polarized light reflected by selective reflection element 17 and incident on second ¼ wave plate 15Bb again is converted into linearly polarized light with a polarization direction inclined at an angle (symmetry) opposite to that at the first incidence with respect to the Y-axis (crystallographic optic axis), the polarization direction substantially coinciding with a polarization direction of the P-polarized light at the second incidence on first light direction conversion element 13. When the linearly polarized light is rotated by 90 degrees, the linearly polarized light becomes S-polarized light at the second incidence.

As a result, when first ¼ wave plate 15Ba and second ¼ wave plate 15Bb are used in combination, effects of both are combined. Thus, the polarization direction at the second incidence on first light direction conversion element 13 substantially coincides with the S polarization direction at the second incidence. Thus, a P-polarized light component that passes through first light direction conversion element 13 and returns to light source unit 3 can be reduced. Then, blue light reflected by first light direction conversion element 13 can be prevented from being reduced, and the amount of fluorescent light converted by wavelength conversion element 25 can be prevented from being reduced.

Light source light Lc0 emitted from light source element 3a passes first ¼ wave plate 15Ba and second ¼ wave plate 15Bb to be converted from blue light of P-polarized light (P-polarized light on a first incident surface of first light direction conversion element 13) to blue light of elliptically polarized light. A part of light source light Lc0 converted into the blue light of the elliptically polarized light by selective reflection element 17 is reflected as first light Lc1, and the rest passes through selective reflection element 17 as second light Lc2. First light Lc1 reflected passes through first ¼ wave plate 15Ba and second ¼ wave plate 15Bb again to be converted from the blue light of the elliptically polarized light to blue light of S-polarized light. First light Lc1 converted into the blue light of the S-polarized light (the S-polarized light on a second incident surface of first light direction conversion element 13) is reflected by first light direction conversion element 13 and travels to wavelength conversion element 25. Although the example has been described here in which the P-polarized light is converted into the S-polarized light, a similar configuration can be applied even when the S-polarized light is converted into the P-polarized light. Light source light Lc0 includes linearly polarized light traveling along the optical axis (P-polarized light at the first incidence on first light direction conversion element 13) that is not affected by action of second ¼ wave plate 15Bb, and that is thus converted into circularly polarized light by first ¼ wave plate 15Ba. The circularly polarized light reflected by selective reflection element 17 and incident on first ¼ wave plate 15Ba again is converted into linearly polarized light (S-polarized light at the first incident on first light direction conversion element 13) acquired by rotating the circularly polarized light by 90 degrees using first ¼ wave plate 15Ba. The linearly polarized light rotated by 90 degrees also travels along the optical axis, and thus can be reflected by first light direction conversion element 13 toward wavelength conversion element 25 without being affected by the action of second ¼ wave plate 15Bb.

As described above, the pair of first ¼ wave plate 15Ba and second ¼ wave plate 15Bb converts the linearly polarized light and the elliptically polarized light to each other, thereby further improving the separation performance between the P-polarized light and the S-polarized light. As a result, the blue light of the S-polarized light reflected by first light direction conversion element 13 can be prevented from being reduced, and the amount of fluorescent light converted by wavelength conversion element 25 can be prevented from being reduced.

### Third Exemplary Embodiment

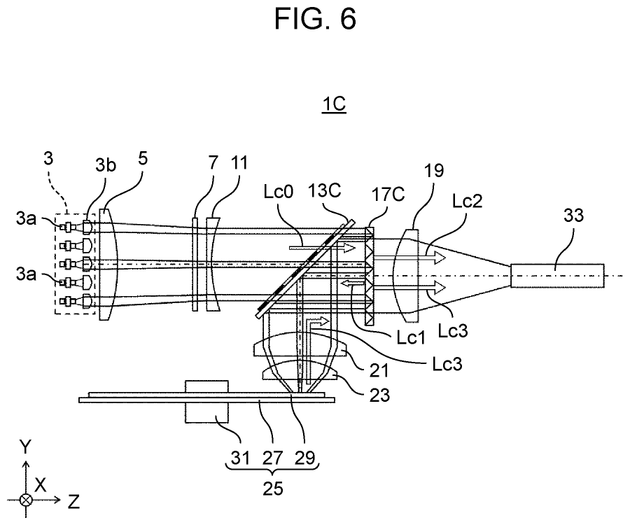

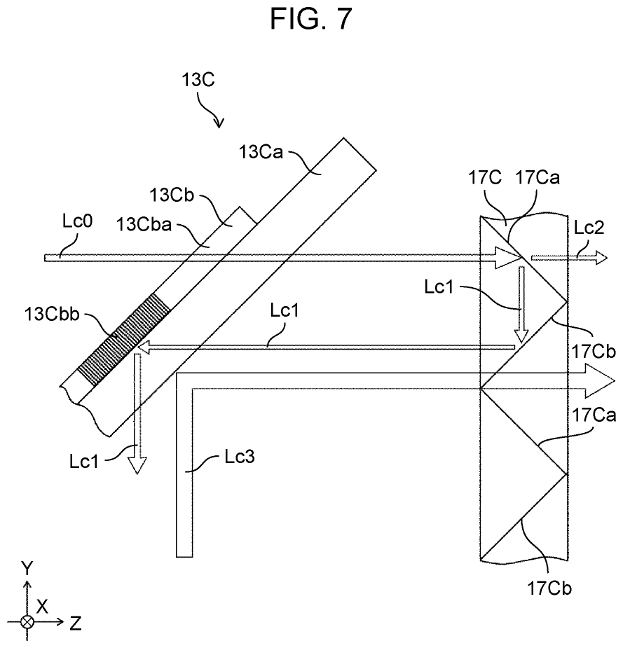

Next, light source device 1C according to a third exemplary embodiment will be described with reference to FIGS. 6 and 7. FIG. 6 is a schematic configuration diagram illustrating a configuration example of a light source device according to the third exemplary embodiment. FIG. 7 is a partially enlarged view of a first light direction conversion element and a selective reflection element of the light source device according to the third exemplary embodiment.

Although selective reflection element 17 of light source device 1 of the first exemplary embodiment separates light source light Lc0 into first light Lc1 and second light Lc2 using polarization characteristics of an optical element, light source device 1C of the third exemplary embodiment eliminates polarization conversion element 15 and separates light source light Lc0 into first light Lc1 and second light Lc2 using a triangular prism array. Thus, light source light Lc0, first light Lc1, and second light Lc2 in the third exemplary embodiment may be in any polarization state or may be unpolarized light. Light source device 1C of the third exemplary embodiment and light source device 1 of the first exemplary embodiment are common in configuration other than the point above and the point described below.

First light direction conversion element 13C includes dichroic mirror 13Ca that transmits light source light Lc0 and first light Lc1 and reflects third light Lc3, and slit mirror 13Cb that transmits light source light Lc0 and reflects first light Lc1. Dichroic mirror 13Ca and slit minor 13Cb may be bonded to each other. Slit mirror 13Cb is disposed closer to light source element 3a than dichroic minor 13Ca.

Slit mirror 13Cb includes slit part 13Cba that transmits light source light Lc0 and reflection part 13Cbb that reflects first light Lc1. Slit part 13Cba and reflection part 13Cbb are alternately disposed side by side. For example, slit part 13Cba is an opening, and reflection part 13Cbb is a dielectric multi-layer film or a metal reflection film. The dielectric multi-layer film may be formed as reflection part 13Cbb on a surface of slit mirror 13Cb, the surface facing dichroic minor 13Ca.

Selective reflection element 17C separates incident light source light Lc0 into first light Lc1 and second light Lc2 to reflect separated first light Lc1 and transmit second light Lc2 and third light Lc3. Selective reflection element 17C shifts first light Lc1 to a position different from that of light source light Lc0 to guide first light Lc1 in a direction opposite to that of light source light Lc0.

Selective reflection element 17C includes first selective reflection part 17Ca that transmits third light Lc3, and reflects a part of light source light Lc0 and transmits the rest, and second selective reflection part 17Cb that transmits third light Lc3, and receives the light reflected by first selective reflection part 17Ca to reflect the light in a direction opposite to that of the light source light. For example, selective reflection element 17C is a triangular prism array in which triangular prisms are alternately bonded, first selective reflection part 17Ca is one oblique side of the triangular prism, and second selective reflection part 17Cb is the other oblique side of the triangular prism. As described above, first selective reflection part 17Ca and second selective reflection part 17Cb are each disposed obliquely with respect to a light beam of incident light source light Lc0.

As in the third exemplary embodiment, a triangular prism array may be used to separate light source light Lc0 into first light Lc1 and second light Lc2 instead of using the polarization characteristics of the optical element, first light Lc1 being converted into third light Lc3 by reciprocating first light Lc1 between selective reflection element 17C and wavelength conversion element 25. Even this configuration enables downsizing of light source device 1C to be achieved as with light source device 1 of the first exemplary embodiment.

### Fourth Exemplary Embodiment

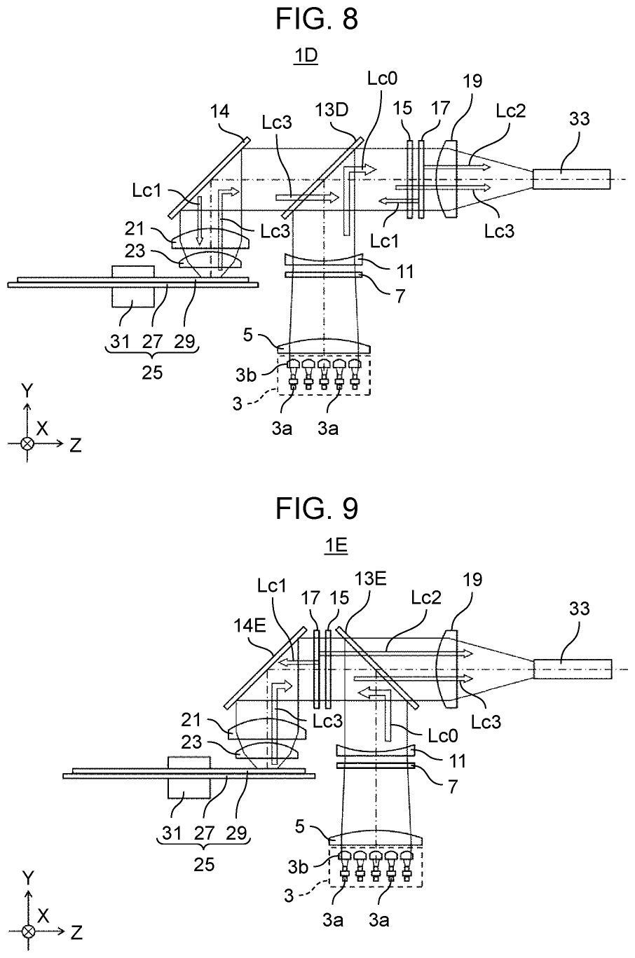

Next, light source device 1D according to a fourth exemplary embodiment will be described with reference to FIG. 8. FIG. 8 is a schematic configuration diagram illustrating a configuration example of a light source device according to the fourth exemplary embodiment.

Although light source device 1 of the first exemplary embodiment includes one light direction conversion element, light source device 1B of the fourth exemplary embodiment includes two light direction conversion elements. Light source device 1D of the fourth exemplary embodiment and light source device 1 of the first exemplary embodiment are common in configuration other than the point above and the point described below.

Light source device 1D includes first light direction conversion element 13D (an example of a second light direction conversion element) and second light direction conversion element 14 (an example of a first light direction conversion element), so that light source unit 3 and wavelength conversion element 25 are disposed on one side in plan view with respect to an optical axis of light emitted from light source device 1D. Second light direction conversion element 14 is disposed parallel to first light direction conversion element 13D and opposite to selective reflection element 17 with respect to first light direction conversion element 13D. Then, second light direction conversion element 14 is disposed at an angle with respect to a traveling direction of first light Lc1 separated by selective reflection element 17 and a traveling direction of third light Lc3 converted by wavelength conversion element 25.

First light direction conversion element 13D has characteristics of reflecting blue light of S-polarized light and transmitting blue light and yellow light of P-polarized light. Thus, when light source light Lc0, which is the blue light of the S-polarized light, is emitted from light source element 3a, for example, first light direction conversion element 13D reflects light source light Lc0. First light direction conversion element 13D also transmits first light Lc1 reflected by selective reflection element 17. First light Lc1 having passed through first light direction conversion element 13D travels to second light direction conversion element 14.

Second light direction conversion element 14 changes a traveling direction of incident first light Lc1 by 90 degrees and reflects first light Lc1 toward wavelength conversion element 25. First light Lc1 incident on wavelength conversion element 25 is converted into third light Lc3 and travels toward second light direction conversion element 14. Second light direction conversion element 14 changes a traveling direction of incident third light Lc3 by 90 degrees and reflects third light Lc3 toward first light direction conversion element 13D. Third light Lc3 passes through first light direction conversion element 13D, polarization conversion element 15, and selective reflection element 17, to be incident on light condensing element 19.

Light source device 1D of the fourth exemplary embodiment can also obtain an effect similar to that of light source device 1 of the first exemplary embodiment. In particular, light source device 1D includes light source element 3a and wavelength conversion element 25 both of which are disposed on one side in plan view with respect to a direction of light emitted from light source device 1D, so that light source device 1D can be incorporated in a thin projection display apparatus, for example.

### Fifth Exemplary Embodiment

Next, light source device 1E according to a fifth exemplary embodiment will be described with reference to FIG. 9. FIG. 9 is a schematic configuration diagram illustrating a configuration example of a light source device according to the fifth exemplary embodiment.

Light source device 1E of the fifth exemplary embodiment also includes two light direction conversion elements as with light source device 1D of the fourth embodiment. Light source device 1E of the fifth exemplary embodiment and light source device 1 of the first exemplary embodiment are common in configuration other than the point above and the point described below.

Light source device 1E includes first light direction conversion element 13E and second light direction conversion element 14E, so that light source unit 3 and wavelength conversion element 25 are disposed on one side in plan view with respect to an optical axis of light emitted from light source device 1E.

First light direction conversion element 13E is disposed at an angle with respect to incident light source light Lc0 to reflect incident light source light Lc0 in a direction opposite to an emission direction from rod integrator 33. First light direction conversion element 13E has characteristics of reflecting incident light source light Lc0 and transmitting second light Lc2 and third light Lc3. For example, first light direction conversion element 13E is a dichroic and polarization separation minor having characteristics of reflecting blue light of S-polarized light and transmitting blue light of P-polarized light and fluorescent light.

Second light direction conversion element 14E is disposed opposite to light condensing element 19 with respect to first light direction conversion element 13E. Then, second light direction conversion element 14E is disposed at an angle with respect to a traveling direction of first light Lc1 separated by selective reflection element 17 and a traveling direction of third light Lc3 converted by wavelength conversion element 25.

Polarization conversion element 15 and selective reflection element 17 are disposed between first light direction conversion element 13E and second light direction conversion element 14E. Polarization conversion element 15 is disposed facing first light direction conversion element 13E, and selective reflection element 17 is disposed facing second light direction conversion element 14E.

When light source light Lc0, which is the blue light of the S-polarized light, is emitted from light source element 3a, for example, first light direction conversion element 13E changes a traveling direction of light source light Lc0, which is the blue light of the S-polarized light, by 90 degrees and reflects light source light Lc0. Light source light Lc0 reflected by first light direction conversion element 13E passes through polarization conversion element 15 to be converted from the S-polarized light to circularly polarized light. A part of light source light Lc0 converted into the circularly polarized light passes through selective reflection element 17 as first light Lc1, and the rest is reflected by selective reflection element 17 as second light Lc2.

Second light Lc2 reflected by selective reflection element 17 passes through polarization conversion element 15 to be converted from the circularly polarized light to P-polarized light, and passes through first light direction conversion element 13E to be incident on light condensing element 19. First light Lc1 having passed through selective reflection element 17 is incident on second light direction conversion element 14E.

Second light direction conversion element 14E is a reflection mirror, for example. Second light direction conversion element 14E changes a traveling direction of incident first light Lc1 by 90 degrees and reflects first light Lc1 toward wavelength conversion element 25. First light Lc1 incident on wavelength conversion element 25 is converted into third light Lc3 and travels toward second light direction conversion element 14E. Second light direction conversion element 14E changes a traveling direction of incident third light Lc3 by 90 degrees and reflects third light Lc3 toward first light direction conversion element 13E. Third light Lc3 passes through selective reflection element 17, polarization conversion element 15, and first light direction conversion element 13E, to be incident on light condensing element 19.

Light source device 1E of the fifth exemplary embodiment can also obtain an effect similar to that of light source device 1 of the first exemplary embodiment. As in the first exemplary embodiment, light source device 1E includes light source element 3a and wavelength conversion element 25 both of which are disposed on one side in plan view with respect to a direction of light emitted from light source device 1E, so that light source device 1E can be incorporated in a thin projection display apparatus, for example.

### Sixth Exemplary Embodiment

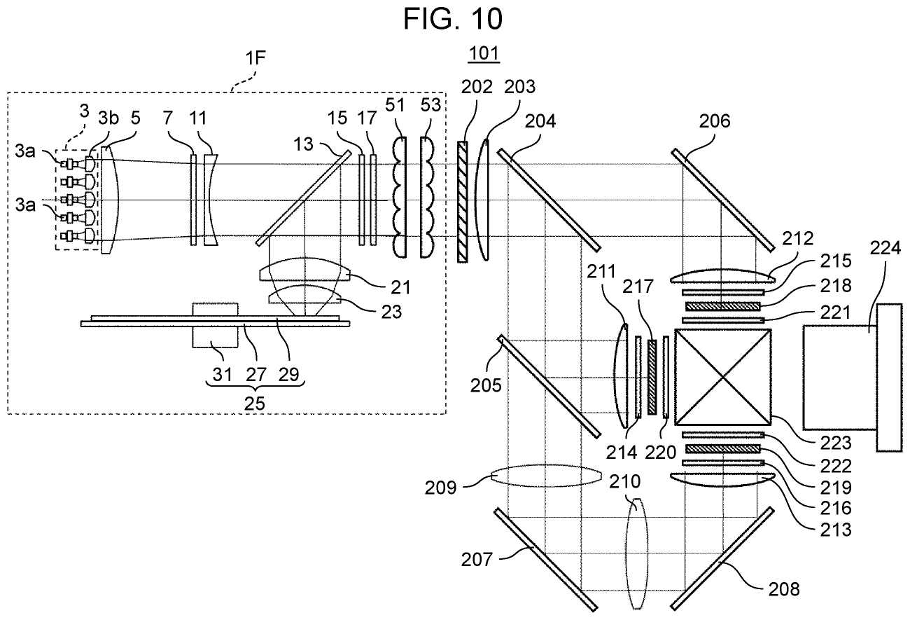

Next, projection display apparatus 101 of a sixth exemplary embodiment will be described with reference to FIG. 10. FIG. 10 is a diagram illustrating a configuration of the projection display apparatus according to the sixth exemplary embodiment.

Projection display apparatus 101 uses, as an image forming unit, an active matrix-type transmissive liquid crystal panel in which a thin film transistor is formed in a pixel region in a twisted nematic (TN) mode or a vertical alignment (VA) mode. Projection display apparatus 101 includes light source device 1F.

Light source device 1F includes first fly-eye lens 51 and second fly-eye lens 53 instead of light condensing element 19 and rod integrator 33 of light source device 1 of the first exemplary embodiment. Projection display apparatus 101 may use the modification of the first exemplary embodiment or light source devices 1B to 1E of the second to fifth exemplary embodiments instead of light source device 1 of the first exemplary embodiment, and may include first fly-eye lens 51 and second fly-eye lens 53 instead of light condensing element 19 and rod integrator 33 in each exemplary embodiment.

Light from selective reflection element 17 is incident on first fly-eye lens 51 including a plurality of lens elements. Flux of the light incident on first fly-eye lens 51 is divided into many fluxes of light. The many divided fluxes of light converge on second fly-eye lens 53 including a plurality of lenses. Each lens element of first fly-eye lens 51 has an opening shape similar to those of liquid crystal panels 217, 218, 219. Second fly-eye lens 53 includes a lens element with a focal length that is determined to allow first fly-eye lens 51 and liquid crystal panels 217, 218, 219 to be in a substantially conjugate relationship. Light from second fly-eye lens 53 is incident on polarization conversion element 202.

Projection display apparatus 101 further includes polarization conversion element 202 that aligns polarization directions, superposition lens 203, dichroic minor 204 that transmits red light and reflects green light and blue light, dichroic minor 205 that reflects green light, reflection mirrors 206, 207, and 208, and relay lenses 209 and 210. Projection display apparatus 101 further includes field lenses 211, 212, 213, incident side polarizing plates 214, 215, 216, liquid crystal panels 217, 218, and 219 as light modulators, emission side polarizing plates 220, 221, 222, color-combining prism 223 including a red-reflecting dichroic minor and a blue-reflecting dichroic mirror, and projection lens unit 224 (an example of a projection optical system).

Polarization conversion element 202 includes a polarization separation prism and a ½ wave plate, and aligns polarization directions of third light Lc3 that is natural light from light source device 1F and second light Lc2 that is circularly polarized light in one polarization direction. Light from polarization conversion element 202 is incident on superposition lens 203. Superposition lens 203 is for superimposing light from each lens element of second fly-eye lens 53 on liquid crystal panels 217, 218, 219 to illuminate them with the superimposed light. Polarization conversion element 202 and the superposition lens 203 serve as an illumination optical system.

The light from superposition lens 203 is separated into blue, green, and red color light by blue and green-reflecting dichroic mirror 204 and green-reflecting dichroic mirror 205 that serve as color separation means. The green light passes through field lens 211 and incident side polarizing plate 214 to be incident on liquid crystal panel 217. The red light is reflected by reflection minor 206, and passes through field lens 212 and incident side polarizing plate 215 to be incident on liquid crystal panel 218. The blue light passes through relay lenses 209, 210 to be refracted, and is reflected by reflection mirrors 207, 208, and then passes through field lens 213 and incident side polarizing plate 216 to be incident on liquid crystal panel 219.

Three liquid crystal panels 217, 218, 219 change a polarization state of the incident light by controlling voltage applied to pixels in response to image signals, and modulate the light using incident side polarizing plates 214, 215, 216 in combination with emission side polarizing plates 220, 221, 222, respectively, the incident side and emission side polarizing plates being disposed on opposite sides of corresponding liquid crystal panels 217, 218, 219 to be each orthogonal to a transmission axis of corresponding one of liquid crystal panels 217, 218, 219, and thus, green, red, and blue images are formed. Each color light having passed through corresponding one of emission side polarizing plates 220, 221, and 222 is incident on color-combining prism 223 where red and blue color light is reflected by the red reflecting dichroic mirror and the blue reflecting dichroic mirror, respectively, to be combined with the green color light, and then the combined light is incident on projection lens 224. Projection lens unit 224 serving as a projection optical system includes a plurality of lenses, and light incident on projection lens unit 224 is enlarged and projected on a screen (not illustrated).

Projection display apparatus 101 of the sixth exemplary embodiment enables improvement in degree of freedom in placement of light source device 1F because light source device 1F is downsized. As a result, projection display apparatus 101 can be downsized.

### Seventh Exemplary Embodiment

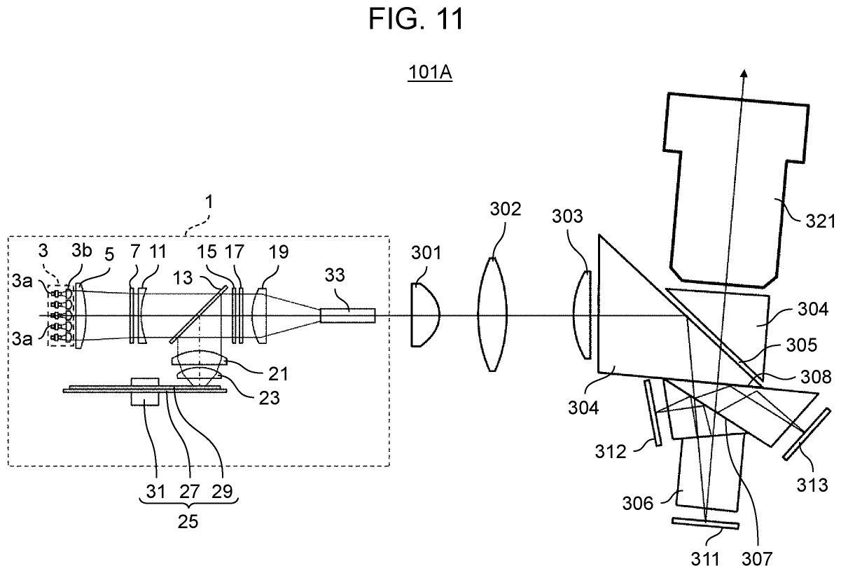

Next, projection display apparatus 101A of a seventh exemplary embodiment will be described with reference to FIG. 11. FIG. 11 is a diagram illustrating a configuration of projection display apparatus 101A according to the seventh exemplary embodiment. Although projection display apparatus 101A of the seventh exemplary embodiment uses light source device 1 of the first exemplary embodiment, the modification of the first exemplary embodiment or light source devices 1B to 1E of the second to fifth exemplary embodiments may be used instead of light source device 1 of the first exemplary embodiment. Projection display apparatus 101A of the seventh exemplary embodiment is a so-called three-chip projection display apparatus.

Light from rod integrator 33 is mapped to digital micromirror device (DMD) 311, 312, 313 as a light modulator through a relay lens system including convex lenses 301, 302, 303.

Light from the relay lens system including convex lenses 301, 302, 303 is incident on total reflection prism 304 provided with minute gap 305. The light transmitted through the relay lens system and incident on total reflection prism 304 at an angle equal to or larger than an angle of total reflection is reflected by minute gap 305 to be changed in traveling direction of the light, and is incident on color prism 306 including three glass blocks provided with a minute gap.

First light Lc1 being blue light and third light Lc3 being fluorescent light incident on a first glass block of color prism 306 from total reflection prism 304 travel such that the blue light is first reflected by a spectral characteristic reflection film having blue reflection characteristics provided at a preceding stage of minute gap 307. Then, the reflected blue light changes in direction of traveling to travel toward total reflection prism 304, and is incident on minute gap 308 provided between total reflection prism 304 and color prism 306 at an angle equal to or larger than the angle of total reflection to be incident on DMD 313 that displays a blue video.

Subsequently, red light of third light Lc3 having passed through minute gap 307 is reflected on a spectral characteristic reflection film that is provided between second and third glass blocks of color prism 306 and has spectral characteristics of reflecting light in a wavelength region of red color and transmitting the green light, and the red light changes in direction of traveling toward the first glass block.

The red light changed in direction of traveling is reflected again by minute gap 307 provided between the first and second glass blocks of color prism 306, and then the red light is changed in direction of traveling to be incident on DMD 312 for red color.

Third light Lc3 having passed through minute gap 307 also include green light that passes through the spectral characteristic reflection film that is provided between the second and third glass blocks of the color prism and has spectral characteristics of reflecting light in the wavelength region of red color and transmitting the green light, and the green light directly travels to the third glass block to be incident on DMD 311 for green color.

DMD 311, 312, 313 changes a traveling direction of light from a video circuit (not illustrated) by changing a direction of a mirror for each pixel in response to an image signal of each color.

The green light changed in direction of traveling in response to an image signal by DMD 311 for green color is incident on the third glass block of color prism 306, and passes through the spectral characteristic reflection film provided between the third and second glass blocks of color prism 306.

The red light changed in direction of traveling in response to an image signal by DMD 312 for red color is incident on the second glass block of color prism 306, and is incident on minute gap 307 provided between the second and first glass blocks of color prism 306 at an angle equal to or larger than the angle of total reflection to be then reflected. After that, the red light changes in direction of traveling toward the third glass block of the color prism, and is reflected on the spectral characteristic reflection film provided between the second and third glass blocks of color prism 306. The red light then changes in direction of traveling to be combined with the green light.

The light combined by the spectral characteristic reflection film travels toward the first glass block of color prism 306, and is incident on minute gap 307 provided between the second and the first glass blocks of color prism 306 at an angle less than or equal to the angle of total reflection to pass through minute gap 307.

Then, the blue light changed in direction of traveling in response to an image signal by DMD 313 for blue color is incident on the first glass block of color prism 306 and travels toward total reflection prism 304. The blue light is then incident on gap 308 provided between total reflection prism 304 and color prism 306 at an angle equal to or larger than the angle of total reflection to travel toward the second glass block of color prism 306. After that, the blue light is reflected by a spectral characteristic minor provided facing the first glass block and in front of minute gap 307 provided between the first and second glass blocks of color prism 306. The blue light is then changed in direction of traveling toward total reflection prism 304, and is combined with light from DMD 311 for green color and DMD 312 for red color to be incident on total reflection prism 304.

The light from DMDs 311, 312, 313 incident on total reflection prism 304 passes through total reflection prism 304, and is incident on projection lens unit 321 as a projection optical system to irradiate the screen (not illustrated).

Projection display apparatus 101A of the seventh exemplary embodiment enables improvement in degree of freedom in placement of light source device 1F because light source device 1F is downsized. As a result, projection display apparatus 101 can be downsized.

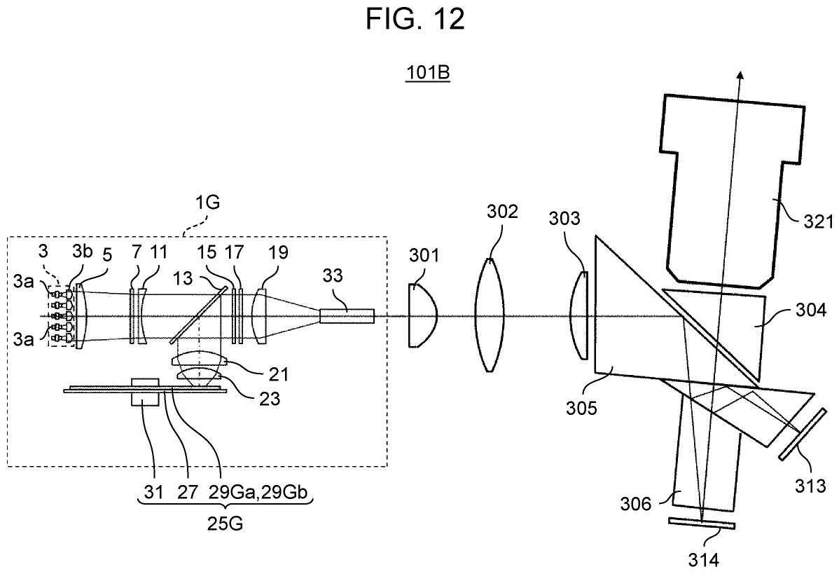

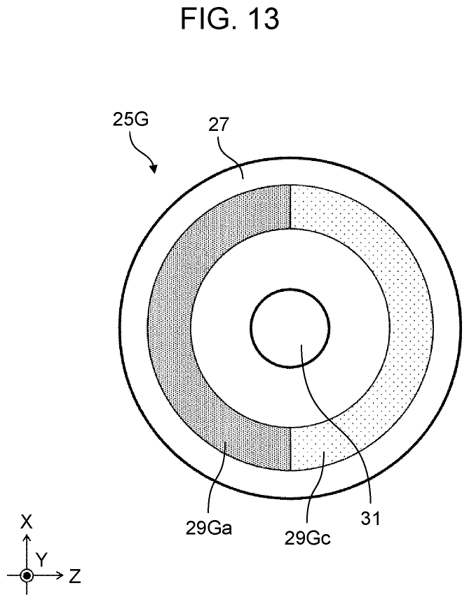

Although projection display apparatus 101A according to the seventh exemplary embodiment is a three-chip projection display apparatus, two-chip projection display apparatus 101B as illustrated in FIG. 12 may be available. In this case, wavelength conversion element 25G of light source device 1G in projection display apparatus 101B includes wavelength conversion layer 29Ga that generates fluorescent light in the wavelength region of green light from incident first light Lg1 that is incident on wavelength conversion layer 29Ga as illustrated in FIG. 12, and wavelength conversion layer 29Gc that generates fluorescent light in the wavelength region of red light from first light Lg1. Each of wavelength conversion layers 29Ga and 29Gc has a semicircular annular segment shape. DMD 314 emits a video in a time division manner in synchronization with rotation of wavelength conversion element 25G.

### Other Exemplary Embodiments

The above exemplary embodiments have been described above as being illustrative of the technique of the present disclosure. The attached drawings and the detailed descriptions have been accordingly presented. Thus, the components described in the accompanying drawings and the detailed description may include not only components essential for solving the problem but also components that are not essential for solving the problem to illustrate the above technique. For this reason, it should not be immediately construed that those non-essential components are essential only based on the fact that those non-essential components are illustrated in the accompanying drawings or described in the detailed description.

The technique in the present disclosure is not limited to the above described exemplary embodiments, and can also be applied to exemplary embodiments in which changes, replacements, additions, omissions, and the like are made. Additionally, the components described in the above-described embodiments can be combined to form a new exemplary embodiment.

The above exemplary embodiment is provided to exemplify the techniques in the present disclosure, so that various changes, replacements, additions, omissions, and the like can be made within the scope of claims and equivalents thereof.

### Overview of Exemplary Embodiments

(1) A light source device according to the present disclosure includes: a light source element that emits light source light that is in a first wavelength region; a selective reflection element that reflects a part of the light source light and transmits a rest of the light source light to separate the light source light into first light and second light, and that transmits third light in a second wavelength region; a first light direction conversion element that is disposed at a position for receiving the first light guided in a first direction from the selective reflection element to reflect the first light and the third light; and a wavelength conversion element that is disposed at a position for receiving light reflected in a second direction by the first light direction conversion element to convert the incident first light into the third light. The first light from the selective reflection element is reflected by the first light direction conversion element in the second direction, and thus is incident on the wavelength conversion element. The third light from the wavelength conversion element is reflected by the first light direction conversion element in a third direction opposite to the first direction, and thus is incident on the selective reflection element. The selective reflection element guides the second light and the third light in the third direction. The light source element emits the light source light in a direction different from the second direction.

The selective reflection element separates the light source light into the first light and the second light and transmits the third light in the second wavelength region to emit the second light and the third light in the third direction, so that the second light and the third light can be simultaneously emitted from the light source device. Additionally, the light source element and the wavelength conversion element are not required to be disposed facing each other, so that the light source device can be downsized.

(2) The light source device of item (1) is configured such that the selective reflection element has a reflectance of 70% or more of the light source light, and a transmittance of 95% or more of the third light.

(3) The light source device of item (1) or (2) includes a light condensing element at a position for receiving light guided by the selective reflection element in the third direction.

(4) The light source device of any one of items (1) to (3) is configured such that the selective reflection element has a reflectance of the light source light, the reflectance varying continuously along a predetermined direction, and varies a ratio of the first light and the second light to be guided by moving in the predetermined direction.

(5) The light source device of any one of items (1) to (4) is configured such that the selective reflection element includes a single dichroic mirror.

(6) The light source device of any one of items (1) to (5) includes a polarization conversion element disposed in an optical path from the light source element to the selective reflection element.

(7) The light source device of item (6) is configured such that the polarization conversion element includes two ¼ wave plates having respective crystallographic optic axes that are not coincident with each other, and converts linearly polarized light and elliptically polarized light to each other.

(8) The light source device of any one of items (1) to (4) is configured such that the selective reflection element includes: a first selective reflection part that is disposed obliquely with respect to a light beam of the light source light incident on the selective reflection element, transmit the third light, reflect a part of the light source light, and transmit a rest of the light source light; and a second selective reflection part that transmits the third light, receives the part of the light source light reflected by the first selective reflection part, and reflects the part of the light source light in a direction opposite to a direction of the light source light. The selective reflection element shifts the first light or the second light to a position different from a position of the light source light and guides the first light or the second light in a direction opposite to the direction of the light source light.

(9) The light source device of any one of items (1) to (8) is configured such that the light source element emits the light source light in the third direction.

(10) The light source device of any one of items (1) to (8) includes a second light direction conversion element that reflects the light source light toward the selective reflection element and transmits the third light.

(11) The light source device of item (10) is configured such that the light source element emits the light source light in a direction opposite to the second direction.

(12) A projection display apparatus according to the present disclosure includes: the light source device of any one of items (1) to (11); a light modulator that generates image light by using the second light and the third light emitted from the light source device; and a projection optical system that projects the image light.

Providing the light source device that can be downsized enables providing a projection display apparatus that can be downsized.

(13) The projection display apparatus of item (12) includes two or more light modulators.

The present disclosure is applicable to a light source device and a projection display apparatus that use light subjected to wavelength conversion performed by a wavelength conversion element.

What is claimed is:

1. A light source device comprising:
a light source element that emits light source light that is in a first wavelength region;
a selective reflection element that reflects a part of the light source light and transmits a rest of the light source light to separate the light source light into first light and second light;
a first light direction conversion element that is disposed at a position for receiving the first light guided in a first direction from the selective reflection element to reflect the first light in a second direction; and
a wavelength conversion element that is disposed at a position for receiving the first light reflected in the second direction by the first light direction conversion element to convert the first light into third light in a second wavelength region,
wherein the first light direction conversion element reflects the third light received from the wavelength conversion element in a third direction opposite to the first direction,
the selective reflection element transmits the third light reflected by the first light direction conversion element,
the selective reflection element guides the second light and the third light in the third direction, and
the light source element emits the light source light in a direction different from the second direction.

2. The light source device according to claim 1, further comprising a light condensing element at a position for receiving light guided by the selective reflection element in the third direction.

3. The light source device of according to claim 1, wherein
the selective reflection element has a reflectance of 70% or more of the light source light, and
the selective reflection element has a transmittance of 95% or more of the third light.

4. The light source device according to claim 1, wherein
the selective reflection element has a reflectance of the light source light, the reflectance varying continuously along a predetermined direction, and
the selective reflection element is moved in the predetermined direction to vary a ratio of the first light and the second light to be guided by the selective reflection element.

5. The light source device according to claim 1, wherein the selective reflection element includes a single dichroic minor.

6. The light source device according to claim 1, further comprising a polarization conversion element disposed in an optical path from the light source element to the selective reflection element.

7. The light source device according to claim 6, wherein
the polarization conversion element includes
a first ¼ wave plate having a first crystallographic optic axis, and
a second ¼ wave plate having a second crystallographic optic axis that is not coincident with first crystallographic optic axis, and
the first and second ¼ wave plates are configured to convert linearly polarized light to elliptically polarized light and convert elliptically polarized light to linearly polarized light.

8. The light source device according to claim 1, wherein
the selective reflection element includes
a first selective reflection part that is disposed obliquely with respect to a light beam of the light source light incident on the selective reflection element, transmit the third light, reflect a part of the light source light, and transmit a rest of the light source light and
a second selective reflection part that transmits the third light, receives the part of light source light reflected by the first selective reflection part, and reflects the part of the light source light in a direction opposite to a direction of the light source light, and
the selective reflection element shifts the first light or the second light to a position different from a position of the light source light and guides the first light or the second light in a direction opposite to the direction of the light source light.

9. The light source device according to claim 1, wherein the light source element emits the light source light in the third direction.

10. The light source device according to claim 1, further comprising a second light direction conversion element that reflects the light source light toward the selective reflection element and transmits the third light.

11. The light source device according to claim 10, wherein the light source element emits the light source light in a direction opposite to the second direction.

12. The light source device according to claim 1, wherein
the light source light is blue light, and
the third light is yellow light.

13. A projection display apparatus comprising:

1. ht source device according to claim 1;
a light modulator that generates image light by using the second light and the third light emitted from the light source device; and
a projection optical system that projects the image light.

14. The projection display apparatus according to claim 13, wherein the light modulator includes two or more light modulators.
